(19) United States
(12) Patent Application Publication
(10) Pub. No.: US 2006/0095594 A1
(43) Pub. Date: May 4, 2006

(54) SYSTEM AND METHOD OF AUTOMATICALLY EXECUTING ATA/ATAPI COMMANDS

(76) Inventors: Jaan-Huei Chen, Taipei Hsien (TW); Yu-Lun Cheng, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/904,319

(22) Filed: Nov. 3, 2004

(51) Int. Cl. G06F 3/00

(52) U.S. Cl. 710/5

(57) ABSTRACT

A method for automatically executing at least a command set to communicate between a host and at least a peripheral device having registers of different sizes, the host comprising a storage device, a host processor, a host controller, and a command interpreter having no additional processor aid, the method comprising: utilizing the host processor to set up the command set in the storage device; utilizing the host processor to trigger the command interpreter to directly read the command set from the storage device; and utilizing the command interpreter to execute the command set for controlling the host controller to access the registers of the peripheral devices.

### BACKGROUND

The invention relates to a system, and more particularly, to a system and a method of automatically executing commands to control data transaction between a host and a peripheral device.

In today's information-oriented society, electronic information accessing devices are increasingly playing a crucial role both in business and home applications. In particular, personal computers (PCs), optical storage media, and other peripheral devices are now well accepted and become important technologies. In order to combine the functions and advantages of these technologies, interconnect buses such as the Integrated Drive Electronics (IDE) bus, also known as the AT Attachment (ATA) bus or the Parallel AT Attachment (PATA) bus, as well as the Serial AT Attachment (SATA) interface are now in wide use.

Please refer to FIG. 1, which is a block diagram of an electronic system 10 according to the related art. The electronic system 10 has a host 11 and an ATA/ATAPI device 18. The host 11 comprises a central processing unit (CPU) 12, a memory 14 electrically connected to the CPU 12, and an ATA/ATAPI host controller 16 electrically connected to the CPU 12 and the memory 14. The ATA/ATAPI device 18 is electrically connected to the ATA/ATAPI host controller 16 through a bus (e.g. an ATA/ATAPI bus). Concerning one operation for transferring data from the host 11 to the ATA/ATAPI device 18, the CPU 12, for example, outputs data required to be delivered to the ATA/ATAPI device 18 to the memory 14, and then controls the ATA/ATAPI host controller 16 to start retrieving data from the memory 14 and then passing the retrieved data to the ATA/ATAPI device 18. However, with regard to another operation for transferring data from the ATA/ATAPI device 18 to the host 11, the CPU 12 controls the ATA/ATAPI host controller 16 to retrieve data from the ATA/ATAPI device 18 and then to store the received data into the memory 14. It is well-known that ATA/ATAPI host controller 16, which is a passive component driven by the CPU 12, communicates with the ATA/ATAPI device 18 according to the ATA/ATAPI protocols.

Traditionally the ATA/ATAPI protocols executed by the CPU 12 are under the way of passing one command to the ATA/ATAPI devices 18 through ATA host controller 16, waiting for the interrupt issued from the ATA/ATAPI device 18, checking the status of the ATA/ATAPI device 18, initiating data transfer as the command desires, checking command execution result, and then going on the next command. It takes several times of intervention for the CPU 12 to complete a data transfer.

For example, if the host 11 has to issue a command to the ATA/ATAPI device 18, the host 11 should check the status of the ATA/ATAPI device 18 first, and then issue a command to the ATA/ATAPI device 18 by writing an I/O register. These steps take several I/O cycles to complete, which are limited to the I/O timing requirement specified by the ATA/ATAPI specification. After a command is issued, the host 11 needs to wait the ATA/ATAPI device 18 to prepare for sending or receiving data. When the device 18 is ready, it asserts an interrupt request INTRQ to notify the host 11 to start transferring data. For the host 11, the interrupt request INTRQ means an inputted interrupt. Therefore, the host 11 needs to handle the event, check status, and then start transferring data. This sequence is repeated until all data are completely transferred. If a peripheral device with a slow response is used, more CPU time is wasted on waiting the response from the peripheral device and checking the status of the peripheral device.

After all data are transferred, the ATA/ATAPI device 18 has to notify the host 11 that the command is completely finished, and the host 11 should check the status again. Taking a multi-task system run by the host 11 for example, the host 11 has to switch tasks for handling several events and wait for many speed-limited I/O cycles to check the status for handling possible errors. Therefore, regardless of the speed of the CPU 12, the more are the ATA/ATAPI commands executed, the more processing time the CPU 12 consumes.

Please refer to FIG. 2, which is a flow chart illustrating a DMA data transfer according to the related art. As shown in FIG. 2, the operation of the DMA data transfer includes following steps.

Step 100: Start;

Step 102: The host 11 reads a status register or an alternative status register until BSY=0 and DRQ=0;

Step 104: The host 11 writes the device/head register with the appropriate DEV bit;

Step 106: The host 11 reads the status register or the alternative status register until BSY=0 and DRQ=0;

Step 108: The host 11 writes required parameters to Features, Sector Count, CHS, and Drive/Head registers;

Step 110: The host 11 initializes a DMA channel;

Step 112: The host 11 writes an ATA/ATAPI command code to a command register;

Step 114: The ATA/ATAPI device 18 sets BSY=1 and prepares to execute the command code;

Step 116: The ATA/ATAPI device 18 checks if an error occurs; if an error occurs, go to step 118; otherwise, go to step 122;

Step 118: The ATA/ATAPI device 18 sets status and error bits;

Step 120: The ATA/ATAPI device 18 checks if the data transfer is continued; if the data transfer is required to continue, go to step 122; otherwise, go to step 126;

Step 122: The ATA/ATAPI device 18 asserts DMARQ and continues transferring data;

Step 124: The ATA/ATAPI device 18 checks if there are still data needed to be transferred; if there are data needed to be transferred, go to step 126; otherwise, go to step 126;

Step 126: The ATA/ATAPI device 18 sets BSY=0 and DRQ=0, asserts INTRQ, deasserts DMARQ, and then goes to step 130;

Step 128: The host 11 resets the DMA channel, and goes to step 132;

Step 130: The ATA/ATAPI device 18 continues asserting DRQ or BSY; and then goes to step 116; and

Step 132: Finish.

Firstly, the host 11 has to check the status of the ATA/ATAPI device 18 (step 102) such that the host 11 polls a busy bit BSY of the status register, which is set by the controller logic of the ATA/ATAPI device 18 to indicate that the ATA/ATAPI device 18 is not accessible, and the data request bit DRQ of the status register, which is set to indicate that the ATA/ATAPI device 18 requests to transfer data between the ATA/ATAPI device 18 and the host 11. Therefore, the host 11 has to wait until the BSY=0 and DRQ=0 (step 104). And then the host 11 writes appropriate DEV bits in the device/head register, which contains the device ID number and its head number for any disk access. After step 104, the host 11 has to check the status of the ATA/ATAPI device 18 again. Therefore, the host 11 polls the status register until BSY=0 and DRQ=0 (step 106). And then, the host 11 writes required parameters to registers of the ATA/ATAPI device 18 for indicating the number of sectors of data waiting to be transferred across the host bus (step 108). Assume that the electronic system 10 are dealing with a command which entails a data transfer, a DMA data transfer for example, to the host 11. Therefore, the host 11 initializes the DMA channel (step 110) and writes the command code to the command register (step 112). In step 114, the ATA/ATAPI device 18 sets BSY=1 and prepares to execute the command code issued by the host 11. Here, if there's an error (step 116), the ATA/ATAPI device 18 sets status and error bits, which contain status information about the last command executed by the ATA/ATAPI device 18 (step 118). After step 118, if data transfer is still needed (step 120), the ATA/ATAPI device 18 asserts DMARQ that signifies when a DMA transfer is to be executed for transferring some data (step 122). If all data are not completely transferred yet (step 124), the ATA/ATAPI device 18 continues asserting BSY or DRQ to keep the DMA transfer alive (step 130), which indicates that the ATA/ATAPI device 18 is ready to transfer data to the host 11 or receive data from the host 11. Additionally, if all data are completely transferred (step 124), the ATA/ATAPI device 18 sets BSY=0 and DRQ=0, asserts INTRQ that is used to interrupt the host 11. In addition, the ATA/ATAPI device 18 deasserts DMARQ (step 126) such that the host 11 resets the DMA channel (step 128). At last the command is completely executed or stopped (step 132).

Please refer to FIG. 3, which is a flow chart illustrating a non-data or a PIO data transfer according to the related art. As shown in FIG. 3, the operation of the PIO data transfer includes following steps.

Step 200: Start;

Step 202: The host 11 reads a status register or an alternate status register until BSY=0 and DRQ=0;

Step 204: The host 11 writes the device/head register with the appropriate DEV bit;

Step 206: The host 11 reads the status register or the alternate status register until BSY=0 and DRQ=0;

Step 208: The host 11 writes required parameters to Features, Sector Count, CHS, and Drive/Head registers;

Step 210: The host 11 writes a command code to a command register;

Step 212: The ATA/ATAPI device 18 sets BSY=1 and prepares to receive data;

Step 214: The ATA/ATAPI device 18 checks if an error occurs; if an error occurs, go to step 216; otherwise, go to step 218;

Step 216: The ATA/ATAPI device 18 sets error and status bits, sets DRQ if desired, and goes to step 220

Step 218: The ATA/ATAPI device 18 sets DRQ=1 when ready to receive data;

Step 220: The ATA/ATAPI device 18 sets BSY=0;

Step 222: The ATA/ATAPI device 18 checks if DRQ=1; if it is, go to step 224; otherwise, go to step 226;

Step 224: The host 11 transfers data to the ATA/ATAPI device 18;

Step 226: The host 11 reads the status register or the alternate status register;

Step 228: The ATA/ATAPI device 18 checks if an error occurs before the data transfer; if an error occurs, go to step 230; otherwise, go to step 232;

Step 230: The ATA/ATAPI device 18 sets BSY=0 and DRQ=0, asserts INTRQ, and goes to step 248;

Step 232: The ATA/ATAPI device 18 sets BSY=1 and processes data delivered from the host 11;

Step 234: The ATA/ATAPI device 18 checks if an error occurs after the data transfer or the data transfer completes; if either an error occurs or data transfer completes, go to step 236; otherwise, go to step 238;

Step 236: The ATA/ATAPI device 18 sets BSY=0, asserts INTRQ, and goes to step 248;

Step 238: The ATA/ATAPI device 18 sets BSY=0 and DRQ=0, asserts INTRQ, and goes to step 240;

Step 240: Are interrupts enabled? If yes, go to step 242; otherwise, go to step 244;

Step 242: The host 11 waits for an interrupt, and goes to step 246;

Step 244: The host 11 reads the alternate status register until BSY=0;

Step 246: The host 11 reads and saves content of the status register, and then goes to step 212; and

Step 248: Finish.

Firstly, steps 200-210 are similar to steps 100-112 shown in FIG. 2. For simplicity, the lengthy description is omitted here. In step 212, the ATA/ATAPI device 18 sets BSY=1 and prepares to receive data. And then the ATA/ATAPI device 18 checks if an error occurs (step 214). If an error occurs, the ATA/ATAPI device 18 sets error and status bits and sets DRQ if desired (step 216). Here, the DRQ is set for indicating that the ATA/ATAPI device 18 has to continue transferring data. On the other hand, if there's no error, the ATA/ATAPI device 18 sets DRQ when ready to receive data. And then the ATA/ATAPI device 18 sets BSY=0 (step 220) and checks if DRQ=1 (step 222). If DRQ=1, the host 11 transfers data to the ATA/ATAPI device 18 (step 224), and then reads the status register or the alternate status register (step 226). If an error occurs (step 228), the ATA/ATAPI device 18 sets BSY=0 and DRQ=0 and asserts INTRQ (step 230). At last the non-data or the PIO data transfer is terminated because of errors (step 248). Additionally, if there's no error (step 228), the ATA/ATAPI device 18 sets BSY=1 and processes data delivered from the host 11 (step 232). And then if an error occurs or data transfer completes (step 234), the ATA/ATAPI device 18 sets BSY=0 and asserts INTRQ to notify the host 11 (step 236). At last the non-data or the PIO data transfer is finished successfully or because of errors (step 248). Furthermore, if there's no error and data transfer is not completed (step 234), the ATA/ATAPI device 18 sets BSY=0 and DRQ=1, and asserts INTRQ to notify the host 11 (step 238). And then, if interrupts are enabled in this electronic system 10, that is, the interrupt function is activated (e.g. the drive interrupt enable bit nIEN is set by 0) in this electronic system 10 (step 240), the host 11 waits for an interrupt (e.g. INTRQ) (step 242). And until the INTRQ is asserted, the host 11 reads and saves content of the status register for clearing pending the interrupt of the ATA/ATAPI device 18 (step 246), and go back to step 212 for transferring following data. On the other hand, if interrupts are not enabled (e.g. nIEN=1) in this electronic system 10 (step 240), the host 11 reads the alternate status register until BSY=0 (step 244), and then reads and saves content of the status register (step 246). And the host 11 goes back to step 212 for transferring following data.

From above description, it is obvious that the host 11 has to handle the whole process of the data transfer. In other words, the host 11 is frequently interrupted during the whole process of the data transfer, and the performance of the CPU 12 is deteriorated owing to the frequently activated task switching.

In the related art, a lot of methods have been disclosed. A normal method is to add another micro-controller to help the host processor to control devices. That is, the host processor sends commands to the micro-controller to control devices. In the afore-mentioned method, although the host processor no longer has to directly control devices because of the micro-controller, the micro-controller can actually be regarded as a processor. In other words, the software of the micro-controller is still utilized to control the devices. Therefore, this related art method does not belong to hardware acceleration.

Furthermore, in US patent application publication NO. 2002/0065995 of Keith Balmer, a batch command is utilized. Therefore, the host processor can first write the content, which is to be written in the device register, in the registers of the host controller. And then the host controller is triggered to write the content from the register of the host controller into the device register. Similarly, the content to be read from the device register can be first written into the host controller, and then the host controller is triggered to read the content. Although this related art method can indeed accelerate the processing speed of the host processor to access the device register, the overall acceleration of the ATA protocol is limited.

Additionally, in U.S. Pat. No. 6,275,879 of Tony Goodfellow, a method of shadowing device regiter is disclosed. That is, the content, which is to be written into the device register, is stored and then is automatically forwarded to a corresponding device. Furthermore, the device register is polled, and the content is shadowed on the host controller. In this related art method, although the host processor is no longer limited by the device register, only the operation related to the device register is accelerated. However, for the whole ATA/ATAPI protocol, the acceleration is still limited.

In U.S. Pat. No. 6,421,760 of Jams Arthur McDonald et al., a host controller, which is totally implemented by hardware, is disclosed to execute the ATA protocol. The host controller can support three operations: (1) reading and checking the content of the device status register; (2) writing eight device registers continuously; and (3) initializing a 256-word data transfer. In this implementation, the host controller can execute the ATA protocol without the host processor. But, in this implementation, another problem occurs. That is, because the host controller is totally implemented by hardware, the host processor could not change the sequence of the operations. The host controller can be only utilized for controlling a normal ATA device. In other words, if an ATAPI device is used or the ATA device is not fully compatible with the host, the host controller is unable to work properly.

The ATA/ATAPI host adapter standard defines a more flexible method. According to this standard, there are three basic operations: (1) writing an eight-bit register; (2) polling a busy bit of a status register; and (3) initializing a data transfer. When the ATA protocol is executed, a series of operations of writing the device register are first executed. Besides, before the device register is written, the busy bit of the status register of the device is polled. After the operations of writing the device register are finished, data transfer is initialized. In this implementation, although it is more flexible than the above-mentioned related art methods and it also achieves the purpose of automatically executing protocol, it cannot support more complicated protocol, for example, the PIO command needing to transfer data many times and the ATAPI command needing to transfer 16-bit data to send the command packet.

Therefore, a more flexible method that can automatically execute the protocol for controlling and accessing an ATA/ATAPI device without the intervention of the micro-controller is desired.

### SUMMARY

It is therefore one of the primary objectives of the claimed invention to provide a system and a method of automatically executing ATA/ATAPI commands to control data transaction between a host and a peripheral device, to solve the above-mentioned problem.

According to an exemplary embodiment of the claimed invention, a method for automatically executing at least a command set to communicate between a host and at least a peripheral device having registers of different sizes is disclosed. The host comprises a storage device, a host processor, a host controller, and a command interpreter having no additional processor aid, the method comprises: utilizing the host processor to set up the command set in the storage device; utilizing the host processor to trigger the command interpreter to directly read the command set from the storage device; and utilizing the command interpreter to execute the command set for controlling the host controller to access the registers of the peripheral devices.

Furthermore, a method for automatically executing at least a command set to transfer data between a host and at least a peripheral device is disclosed. The host comprises a storage device, a host processor, a host controller having no additional processor aid, and a command interpreter, and the method comprises: utilizing the host processor to set up the command set in the storage device; utilizing the host processor to trigger the command interpreter to directly read the command set from the storage device; utilizing the command interpreter to execute the command set for assigning a size of a data block per transmission to the host controller; and utilizing the command interpreter to execute the command set for triggering the host controller to start a data transfer between the host and the peripheral device.

It is one advantage of the present invention that the system makes use of the command interpreter to automatically execute ATA/ATAPI commands so that loading of the CPU is greatly alleviated. In other words, because the number of interrupts affecting the CPU is greatly reduced, the performance of the CPU is improved.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an electronic system according to the related art.

FIG. 2 is a flow chart illustrating a DMA data transfer according to the related art.

FIG. 3 is a flow chart illustrating a non-data or a PIO data transfer according to the related art.

FIG. 4 is a block diagram of an electronic system according to an embodiment of the present invention.

FIG. 5 is a table illustrating command codes in a command set according to the present invention.

FIG. 6 and FIG. 7 are flow charts illustrating operation of a command interpreter shown in FIG. 4.

### DETAILED DESCRIPTION

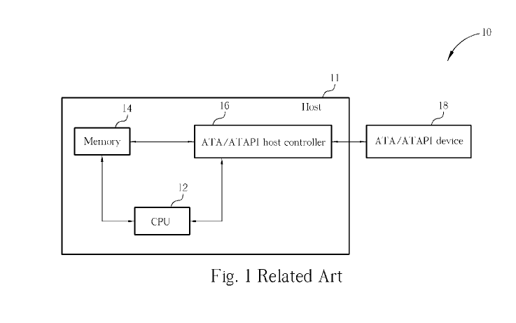

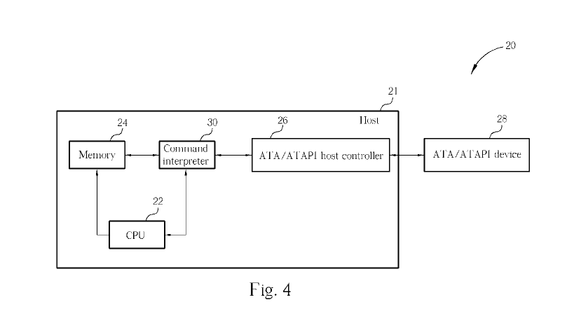

Please refer to FIG. 4, which is a block diagram of an electronic system 20 according to an embodiment of the present invention. Similar to the electronic system 10 shown in FIG. 1, the electronic system 20 according to the present invention has a host 21 and an ATA/ATAPI device 28. The host 21 comprises a memory 24 for storing a plurality of command sets and data, a central processing unit (CPU) 22 electrically connected to the memory 24 for setting up the command sets and storing the command sets into the memory 24, an ATA/ATAPI host controller 26 electrically connected to the ATA/ATAPI device 28 (e.g. an optical disk drive or a magnetic disk drive) for communicating with the ATA/ATAPI device 28, and a command interpreter 30. The main difference between the host 11 shown in FIG. 1 and the host 21 shown in FIG. 4 is that the electronic system 20 has the command interpreter 30 electrically connected to the CPU 22, the memory 24, and the ATA/ATAPI host controller 26 for handling each command set prepared by the CPU 22, getting the needed data from the memory 24 according to the enabled command set, transferring the needed data to the ATA/ATAPI host controller 26, and communicating with the ATA/ATAPI host controller 26. Here, please note that the ATA/ATAPI host controller 26 can support multiple ATA/ATAPI devices, the number of the ATA/ATAPI device 28 is only used for illustration, not a limitation. In addition, the ATA/ATAPI host controller can access host memory directly.

In this embodiment, the command interpreter 30 functions as an agent of the CPU 22 to control the data transaction between the ATA/ATAPI host controller 26 and the ATA/ATAPI device 28. The command interpreter 30 can help the CPU 22 to drive the ATA/ATAPI host controller 26, such as handling INTRQ generated from the ATA/ATAPI device 28, loading the command set from the memory 24, and executing command codes in the command set. Therefore, during the data transfer, the CPU 22 in the host 21 only has to deal with responses outputted from the command interpreter 30, and does not have to directly handle each response delivered from the ATA/ATAPI device 28. For example, when a lot of data blocks are required to be transferred between the host 21 and the ATA/ATAPI device 28, the ATA/ATAPI device 28 has to inform the host 21 by the INTRQ each time it is ready to receive data corresponding to an ATA/ATAPI command. But in this embodiment, the ATA/ATAPI device 28 informs the command interpreter 30 instead of the CPU 22. The command interpreter 30 handles the INTRQ and executes following command codes in the command set, and the command interpreter 30 informs the CPU 22 of the data transfer status only when the command set is normally completed or an error abnormally occurs. Therefore, the number of interrupts inputted into the CPU 22 is reduced so that the CPU 22 can have greater performance.

Please note that, in this embodiment, because the command interpreter 30 is capable of efficiently dealing with parts of CPU's work, the CPU 22 sets up a plurality of command sets in the memory 24 instead of a plurality of single ATA/ATAPI command. This makes the ATA/ATAPI commands executed automatically to achieve better data transfer performance. Additionally, the command sets are executed in the form of a command queue, which means that each command set in the command queue contains the information of the next command set and the corresponding address in the memory 24. Besides, in this embodiment, the command set is composed of a plurality of command codes to define a plurality of ATA/ATAPI host controller 26 operations, such as writing the device's register, polling the device's register, checking the device's register, and so on.

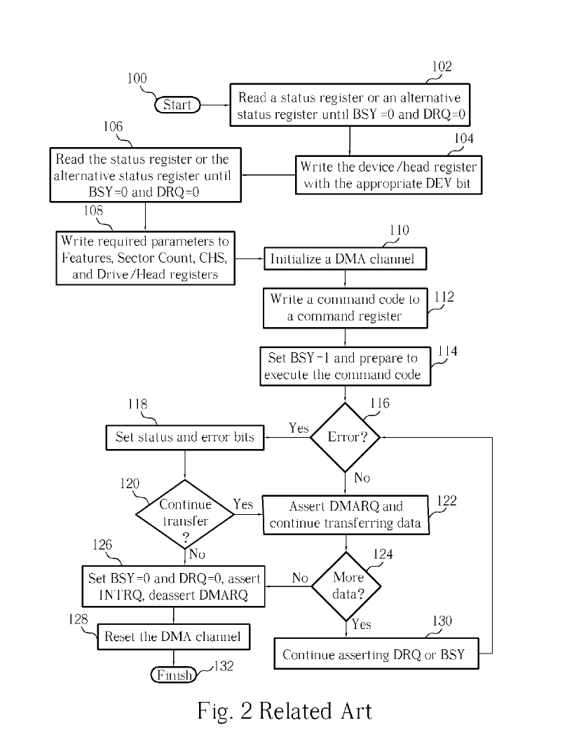

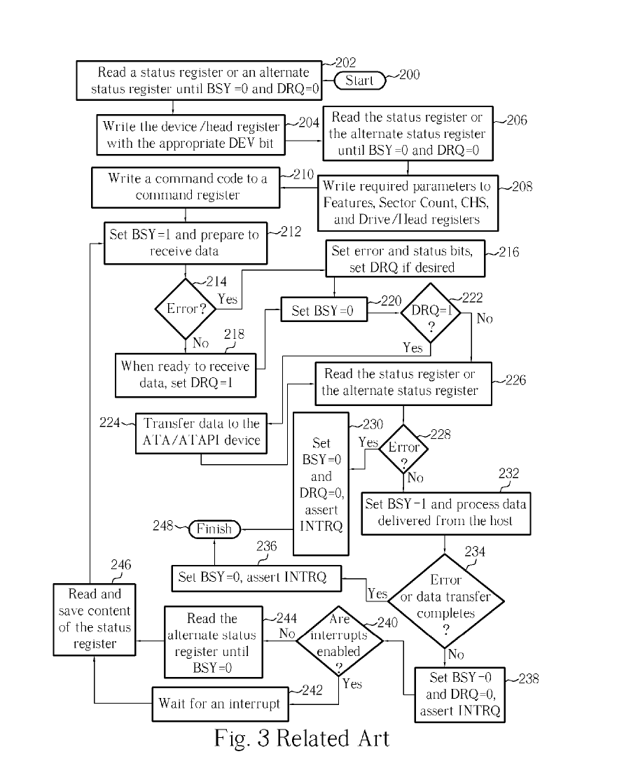

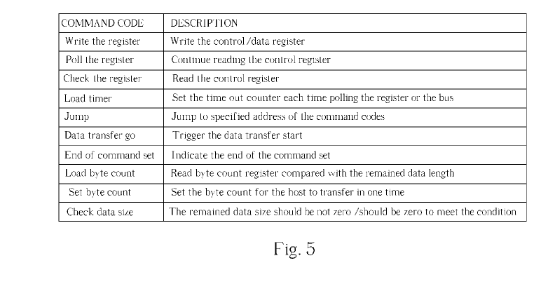

Please refer to FIG. 5 in conjunction with FIGS. 2 and 3. FIG. 5 is a table illustrating command codes in a command set according to the present invention. The command set is executed by the command interpreter 30 shown in FIG. 4. That is, the command interpreter 30 executes a command set including needed command codes to implement the flow shown in FIG. 2 or FIG. 3. For example, one command code is used to support a corresponding step in FIG. 2 or FIG. 3. The command interpreter 30 runs “check the register” to drive the ATA/ATAPI host controller 26 to read the content kept by a control register and then compare the content with specified masks. On the other hand, when the command interpreter 30 wants to drive the ATA/ATAPI host controller 26 to write parameters to a command register (step 112) (steps 114, 126), the command code “write the register” is used. When the ATA/ATAPI host controller 26 initiates the data transfer between the ATA/ATAPI host controller 26 and the ATA/ATAPI device 28, the command interpreter 30 first executes the command code “set byte count” for driving the interface controller to set a data transfer size per data transmission for the data transferred between the storage device and the peripheral device. Here, please note that in the ATA PIO/DMA command protocol, the data transfer size per data transmission is set by the host 21. Therefore, the command interpreter 30 does not have to execute the command “load byte count” to know the above-mentioned data transfer size. But in PACKET command protocol (ATAPI protocol), because the data transfer size per data transmission is set by the ATA/ATAPI device 28, the command interpreter have to execute the command “load byte count” in order to detect the data transfer size before the data transmission is started. The command interpreter then executes the command code “data transfer go” to drive the ATA/ATAPI host controller 26 to start transferring data to the ATA/ATAPI device 28. Please note that a hardware timer is provided by the command interpreter 30, and the command interpreter 30 can execute the command code “load timer” before any of other command codes to prevent the following command code from hanging, including “data transfer go” command. Furthermore, the CPU 22 could also implement a software timer for the whole command execution and abort the command interpreter command execution when the software timer timeout.

After the ATA/ATAPI device 28 starts to process the command, and an error (e.g. a CRC error during data transfer) occurs, the device not only sets status and error bits, but also asserts an INTRQ to inform the host 21. In this embodiment, after the command interpreter 30 receives INTRQ generated from the ATA/ATAPI device 28 through the ATA/ATAPI host controller 26, the command interpreter 30 according to the present invention determines whether the INTRQ is passed to the CPU 22 or not. In other words, if the command interpreter 30 decides to pass INTRQ to notify the CPU 22 of the error, the CPU 22 will activate an interrupt service routine to handle this INTRQ, and further determines whether the data transfer is aborted or not. However, if the command interpreter 30 decides not to pass INTRQ to notify the CPU 22 of the error, the CPU 22 is not interrupted, and the command code execution continues to handle the INTRQ. To sum up, the command interpreter 30 can be designed to deliver or not to deliver the received INTRQ to the CPU 22 according to the design requirement.

In the end of the command set there is a command code named command end. It's used to inform the command interpreter that a command set is executed without failure condition till now. The command interpreter will inform the host processor of the completeness of the command set if needed and will go on the next command set if there is any.

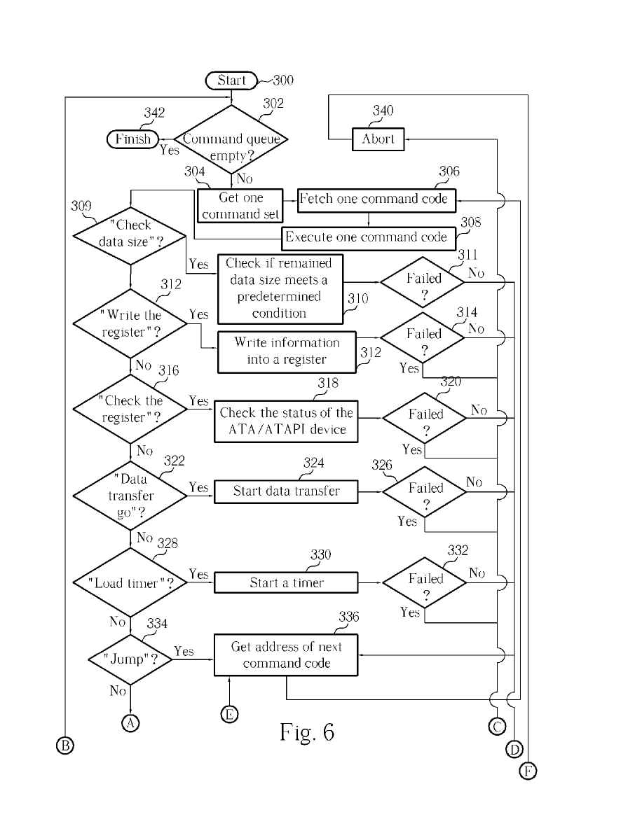

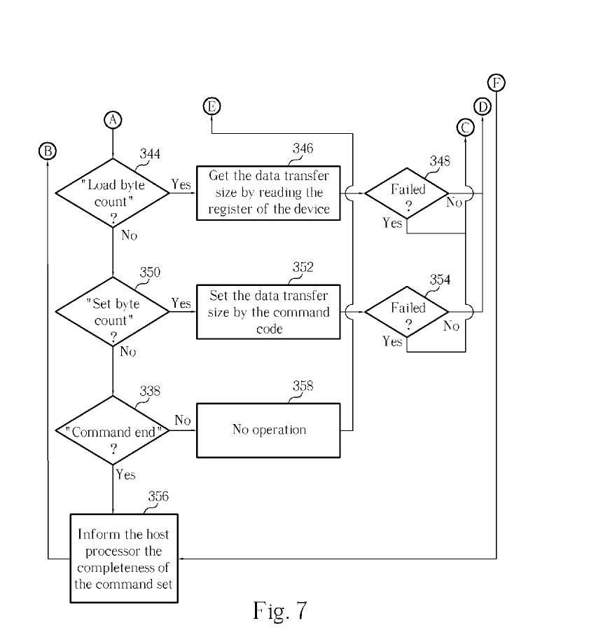

Please refer to FIG. 6 and FIG. 7, which are flow charts illustrating operation of the command interpreter 30 shown in FIG. 4. In FIG. 6 and FIG. 7, the command set executed by the command interpreter 30 only comprises some command codes, that is, “check data size”, “write the register”, “check the register”, “load byte count”, “set byte count”, “load timer”, “jump”, and “command end” for simplicity. However, the number of command codes in the command set is not limited. This operation of the command interpreter 30 includes following steps:

Step 300: Start;

Step 302: Check whether a command queue in the memory 24 is empty; if the command queue is empty, go to step 342; otherwise, go to step 304;

Step 304: Get one command set;

Step 306: Fetch one command code from the retrieved command set;

Step 308: Execute the selected command code;

Step 309: Check whether the command code is “check data size”; if it is, go to step 310; otherwise, go to step 312;

Step 310: Check if remained data size meets a predetermined condition;

Step 311: Does the remained data size fail to meet the predetermined condition? If yes, go to step 340; otherwise, go to step 336;

Step 312: Check whether the command code is “write the register”; if it is, go to step 313; otherwise, go to step 316;

Step 313: Write information into a register of the ATA/ATAPI device 28;

Step 314: Is the execution of the command code “write the register” failed? If yes, go to step 340; otherwise, go to step 336;

Step 316: Check whether the command code is “check the register”; if it is, go to step 314; otherwise, go to step 322;

Step 318: Check the status of the ATA/ATAPI device 28;

Step 320: Is the execution of the command code “check the register” failed? If yes, go to step 340; otherwise, go to step 336;

Step 322: Check whether the command code is “data transfer go”; if it is, go to step 324; otherwise, go to step 328;

Step 324: Start the data transfer;

Step 326: Is the execution of the command code “data transfer go” failed? If yes, go to step 340; otherwise, go to step 336;

Step 328: Check whether the command code is “load timer”; if it is, go to step 330; otherwise, go to step 334;

Step 330: Start a timer;

Step 332: Is the execution of the command code “load timer” failed? If yes, go to step 340; otherwise, go to step 336;

Step 334: Check whether the command code is “jump”; if it is, go to step 336; otherwise, go to step 338;

Step 336: Get the memory address of a next command code, and then go back to step 306;

Step 338: Check whether the command code is “end of command set”; if it is, go to step 356; otherwise, go to step 358;

Step 340: Abort the command set, and then go to step 356;

Step 342: Finish.

Step 344: Check whether the command code is “load byte count”; if it is, go to step 346; otherwise, go to step 350;

Step 346: Get the data transfer size by reading the register of the device;

Step 348: Is the execution of the command code “load byte count” failed? If yes, go to step 340; otherwise, go to step 336;

Step 350: Check whether the command code is “set byte count”; if it is, go to step 352; otherwise, go to step 338;

Step 352: Get the data transfer size by the command code;

Step 354: Is the execution of the command code “set byte count” failed? If yes, go to step 340; otherwise, go to step 336;

Step 356: Inform the host processor the completeness of the command set, and then go to step 302;

Step 358: No operation; go to step 336;

Firstly, the CPU 22 sets up a plurality of command sets, and stores these command sets in a command queue allocated inside the memory 24. Then the CPU 22 controls the command interpreter 30 to start accessing the command queue (step 300). The command interpreter 30 checks if the command queue is empty (step 302). If the command queue is empty, it means that all of the command sets originally stored in the command queue are popped out and executed. Therefore, the command interpreter 30 has finished processing the command sets assigned by the CPU 22 (step 342). However, if the command queue is not empty, the command interpreter 30 reads the command queue in the memory 24, and loads one command set according to the characteristic “first in first out” of command queue (step 304). Additionally, the command interpreter 30 fetches one command code from the retrieved command set (step 306).

And then the command interpreter 30 determines that what kind of command code it is. Therefore, the command interpreter 30 checks whether the command code is “check data size” (step 309), “write the register” (step 312), “check the register” (step 316), “data transfer go” (step 322), “load timer” (step 328), “load byte count” (step 344), “set byte count” (step 350), “command end” (step 338), or “jump” (step 334). Obviously, if the command code is “check data size” (step 309), the command interpreter 30 has to control the ATA/ATAPI host controller 26 to detect the remained data size for examining the data transfer progress of the current command set (step 310). For instance, the predetermined condition is set to a data size equaling 0. If the checked remained data size is equal to 0, the command interpreter 30 deems that the all data are transferred because the predetermined condition is met. For other command codes, if the command code is “write the register” (step 312), the command interpreter 30 has to control the ATA/ATAPI host controller 26 to write information into a register. For example, the parameters related to the storage location are written into registers positioned on the ATA/ATAPI device 28. Similarly, if the command code is another command code (such as “load timer”, “check the register”, and so on), the command interpreter 30 has to perform corresponding operation (steps 310, 313, 318, 324, 330, 336, 346, 352). In steps 311, 314, 320, 326, 332, 348, 354, the command interpreter 30 checks whether the operations run in steps 310, 313, 318, 324, 330, 336, 352 are successfully executed or not. If the command interpreter 30 checks that execution of the command code fails to achieve a desired result (steps 311, 314, 320, 326, 332, 348, 354), or the timer calls timeout (step 332), the command interpreter 30 aborts the currently selected command set (step 340), and goes back to step 302 for checking whether the command queue is empty. As mentioned above, when the command interpreter 30 aborts the command set, the command interpreter 30 informs the CPU 22 through an interrupt, and the CPU 22 will determine how to handle this execution failure after being acknowledged by the command interpreter 30. For example, the CPU 22 sets up another command queue or sends a failure message to the user.

If the command is “jump” (step 334), it means that the command interpreter 30 has to jump to execute another command code in the command set, instead of the following command code. As mentioned above, each command code comprises information of next command code. Basically, the command interpreter 30 sequentially executes the command codes except for “jump”. Therefore, if the command interpreter 30 runs the command code “jump”, the command interpreter 30 gets the memory address of the next command first (step 336), and then fetches the next command code from the same command set (step 306). Here, please note that there are two kinds of jump commands, where one kind of the jump command is “directly jump”, and the other jump command is “conditional jump”. The conditional jump command whether the jump operation is performed or not according to the result of “check data size” command code. However, if the command code performed by the command interpreter 30 is not any of the above-mentioned command, the command interpreter 30 is sure that the command code is “no operation” and execute next command code (step 358). If the command is “command end” (step 338), it means that the protocol defined in the command set is executed to the finish by the command interpreter 30. Therefore, the command interpreter 30 informs the host processor the completeness of the command set (step 356) then checks the command queue again (step 302). On the contrary, if the command set is not finished yet, the command interpreter 30 gets the memory address of the next command code (step 336), and fetches the next command code (step 306).

Please note that the order of checking what the command code is in FIG. 6 and FIG. 7 is only an example and is not meant to be a limitation. In other words, the command interpreter 30 can first check whether the command code is “load timer” and then check whether the command code is “check the register”. This doesn't disobey the spirit of the present invention. That is, the command interpreter 30 according to the present invention is capable of processing various command codes, and even, processing those command codes through different orders. And please note that the present invention can be utilized in both DMA data transfer and PIO data transfer.

As mentioned above, the command interpreter 30 is capable of executing operations originally performed by the host 12 according to the ATA/ATAPI protocol through executing a command set configured by the host 21. As a result, without the intervention of another micro-controller or the host 12, the wanted operations are capable of being successfully completed. Especially for the PIO data transmission, the command interpreter 30 can support not only a single data block per transmission but also multiple data blocks per transmission regardless of the data block having a single sector or multiple sectors.

In addition, if the command interpreter 30 has to support the PACKET command protocol utilized by the ATAPI device, the above-mentioned operation has to be modified correspondingly. That is, after the command is sent, another 12-byte command packet is sent through the way of 16-bit data writing. Here, the 12-byte command packet is part of the command, not data. Please note that a normal device register, for example, the device/head and command register, is an 8-bit register. Therefore, the command code should be designed to support 8-bit and 16-bit operations at the same time in order to support all devices connected to the IDE bus (for example, ATAPI devices). Furthermore, for the PACKET command, regardless of the PIO or DMA transmission mode, the device may interrupt the command even if the host does not receive all of the required data. This problem cannot be solved by the related art system. Therefore, it has to be processed by the host processor or the additional micro-controller. But here, the system according to the present invention can incorporate the related exception-handling command codes into a command set to handle above problem.

In contrast to the related art, the system according to the present invention makes use of the command interpreter to automatically execute ATA/ATAPI commands so that loading of the CPU is greatly alleviated. In other words, because the number of interrupts affecting the CPU is greatly reduced, the performance of the CPU is improved. Furthermore, the present invention command interpreter does not need another processor to deal with protocol, and can support all protocols, which are based on the operation of registers, through a command set determined by the host processor because of the proper design of command codes.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for automatically executing at least a command set to communicate between a host and at least a peripheral device having registers of different sizes, the host comprising a storage device, a host processor, a host controller, and a command interpreter having no additional processor aid, the method comprising:
utilizing the host processor to set up the command set in the storage device;
utilizing the host processor to trigger the command interpreter to directly read the command set from the storage device; and
utilizing the command interpreter to execute the command set for controlling the host controller to access the registers of the peripheral devices.

2. The method of claim 1 wherein the peripheral device is an ATA/ATAPI device, and the host controller is an ATA/ATAPI host controller.

3. The method of claim 1 wherein the command set comprises a command code, and the method further comprises:
utilizing the command interpreter to time an execution of the command code, wherein the command interpreter aborts the execution of the command code when the execution of the command code exceeds a predetermined period.

4. The method of claim 1 further comprises utilizing the command interpreter to execute a command code for indicating an end of the command set.

5. The method of claim 1 wherein the command set comprises a command code, and the method further comprises:
utilizing the command interpreter to execute the command code for driving the host controller to detect if a signal from the peripheral device is changed.

6. The method of claim 5 wherein the signal is an INTRQ.

7. The method of claim 6 wherein the command interpreter is capable of determining whether the INTRQ is passed to the host processor or not.

8. The method of claim 1 wherein the command set comprises a plurality of command codes, and the method further comprises:
utilizing the command interpreter to execute a command code for evaluating the content of a register of the peripheral device which is assigned by the command code, wherein if a predetermined condition is met, an execution of a following command code is aborted.

9. A method for automatically executing at least a command set to transfer data between a host and at least a peripheral device, the host comprising a storage device, a host processor, a host controller having no additional processor aid, and a command interpreter, the method comprising:
utilizing the host processor to set up the command set in the storage device;
utilizing the host processor to trigger the command interpreter to directly read the command set from the storage device;
utilizing the command interpreter to execute the command set for assigning a size of a data block per transmission to the host controller; and
utilizing the command interpreter to execute the command set for triggering the host controller to start a data transfer between the host and the peripheral device.

10. The method of claim 9 wherein the command set comprises a command code, and the size of the data block per transmission is indicated in the command code.

11. The method of claim 9 wherein the command set comprises a command code, and the size of the data block per transmission is obtained by utilizing the command interpreter to execute the command code to read the peripheral device for.

12. The method of claim 9 wherein the command set comprises a plurality of command codes, and the method further comprises:
utilizing the command interpreter to execute a command code to check if a remained data size associated with the issued command code meets a predetermined condition.

13. The method of claim 12 wherein if the predetermined condition is met, the command interpreter stops executing a following command code.

14. The method of claim 12 wherein the following command code executing sequence is determined by the checking result of the issued command code.

15. The method of claim 9 wherein the peripheral device is an ATA/ATAPI device, and the host controller is an ATA/ATAPI host controller.

16. The method of claim 9 wherein the command set comprises a command code, and the method further comprises:
utilizing the command interpreter to execute the command code to set up a timer and the command interpreter aborts the data transfer when the timer expires without an intervention of the host processor.
